(19) United States
(12) Patent Application Publication
(10) Pub. No.: US 2014/0359286 A1
(43) Pub. Date: Dec. 4, 2014

(54) CONTACT MANAGEMENT METHOD, APPARATUS AND SYSTEM FOR THIRD-PARTY APPLICATION

(71) Applicant: TENCENT TECHNOLOGY (SHENZHEN) COMPANY LIMITED, Shenzhen (CN)

(72) Inventors: Xiaomu WEN, Shenzhen (CN); Lei LI, Shenzhen (CN); Yu CHEN, Shenzhen (CN); Jing HE, Shenzhen (CN); Mengsong TANG, Shenzhen (CN); Junshan WANG, Shenzhen (CN); Bin LI, Shenzhen (CN)

(73) Assignee: TENCENT TECHNOLOGY (SHENZHEN) COMPANY LIMITED, Shenzhen (CN)

(21) Appl. No.: 14/263,617

(22) Filed: Apr. 28, 2014

Related U.S. Application Data
(63) Continuation of application No. PCT/CN2013/088890, filed on Dec. 9, 2013.

(30) Foreign Application Priority Data
May 30, 2013 (CN) 201310209735.0

(51) Int. Cl. G06F 21/62; G06F 17/30

(52) U.S. Cl. CPC G06F 21/6245; G06F 17/30581
USPC 713/167

(57) ABSTRACT

A contact management method, apparatus and system for a third-party application are described. The contact management method includes: detecting an instruction to obtain a contact, wherein the instruction is input by a user operating the third-patty application; reading contact data in an address book in responsive to the instruction to obtain the contact; encrypting the contact data and obtaining an encrypted contact data; importing the encrypted contact data into a contact data table of the third-party application; and uploading the encrypted contact data in the contact data table to a cloud server, so that a mapping relationship between account information of the user and the encrypted contact data is established at the cloud server, wherein the account information of the user is used for logging in the third-party application. In the method, the apparatus and the system, safety and reliability of the contact data can be improved.

### CROSS REFERENCE TO RELATED APPLICATIONS

This application is a continuation application of PCT Patent Application No. PCT/CN2013/088890, entitled “CONTACT MANAGEMENT METHOD, APPARATUS AND SYSTEM FOR THIRD-PARTY APPLICATION”, filed on Dec. 9, 2013, which claims priority to Chinese Patent Application No. 201310209735.0, entitled “CONTACT MANAGEMENT METHOD, APPARATUS AND SYSTEM FOR THIRD-PARTY APPLICATION” and filed on May 30, 2013, both of which are hereby incorporated in their entireties by reference.

### FIELD OF THE TECHNICAL

The present disclosure relates to the technical field of internet, and in particular, to a contact management method, a contact management apparatus and a contact management system for a third-party application.

### BACKGROUND

This section provides background information related to the present disclosure which is not necessarily prior art.

An address book is an indispensable tool for contact management in mobile phones. The open features of the address book make contact data in it accessible by different third-party applications in the mobile phone. In practical application, when a certain third-party application implements an operation on the contact data, such as adding data, deleting data, or modifying data, the operation may be known by other third-party applications, causing risk of contact data leakage. In addition, loss of contact data in the address book will also cause loss to the third-party applications.

### SUMMARY

One embodiment of the present invention provides a contact management method, a contact management apparatus and a contact management system for a third-party application, in which safety and reliability of contact data can be improved.

According to one aspect of the present invention, it is provided a contact management method for a third-party application, comprising: detecting an instruction to obtain a contact, wherein the instruction is input by a user for operating the third-party application; reading contact data in an address book in responsive to the instruction to obtain the contact; encrypting the contact data and obtaining an encrypted contact data; importing the encrypted contact data into a contact data table of the third-party application; and uploading the encrypted contact data in the contact data table to a cloud server, so that a mapping relationship between account information of the user and the encrypted contact data is established at the cloud server, wherein the account information of the user is used for logging in the third-party application.

According to another aspect of the present invention, it is provided a contact management method for a third-party application, comprising: detecting, at a terminal device, an instruction to obtain a contact, wherein the instruction is input by a user for operating the third-party application; reading, at the terminal device, contact data in an address book in responsive to the instruction to obtain the contact; encrypting, at the terminal device, the contact data and obtaining an encrypted contact data; importing, at the terminal device, the encrypted contact data into a contact data table of the third-party application; uploading, at the terminal device, the encrypted contact data in the contact data table to a cloud server; and establishing, at the cloud server, a mapping relationship between account information of the user and the encrypted contact data, wherein the account information of the user is used for logging in the third-party application.

According to yet another aspect of the present invention, it is provided a computer storage medium storing computer-executable instructions that, when executed by a processor, perform all of step of the contact management method for a third-party application disclosed by one embodiment of the present invention.

According to yet another aspect of the present invention, it is provided a contact management apparatus for a third-party application, comprising: a detecting unit configured to detect an instruction to obtain a contact, wherein the instruction is input by a user for operating the third-party application; a reading unit configured to read contact data in an address book in responsive to the instruction to obtain the contact; an encrypting unit configured to encrypt the contact data and obtain an encrypted contact data; an import uniting configured to import the encrypted contact data into a contact data table of the third-party application; and an transmission unit configured to upload the encrypted contact data in the contact data table to a cloud server, so that a mapping relationship between account information of the user and the encrypted contact data is established at the cloud servers, wherein the account information of the user is used for logging in the third-party application.

According to yet another aspect of the present invention, it is provided a contact management system for a third-party application, comprising a terminal device and a cloud server, wherein the terminal device is configured to: detect an instruction to obtain a contact, wherein the instruction is input by a user for operating the third-party application; read contact data in an address book in responsive to the instruction to obtain the contact; encrypt the contact data and obtain an encrypted contact data; import the encrypted contact data into a contact data table of the third-party application; and upload the encrypted contact data in the contact data table to the cloud server; and the cloud server is configured to: establish a mapping relationship between account information of the user and the encrypted contact data, wherein the account information of the user is used for logging in the third-party application.

In various embodiments of the present invention, after detecting an instruction to obtain a contact input by a user for operating the third-party application, contact data in an address book may be read in responsive to the instruction to obtain the contact and may be encrypted to obtain an encrypted contact data. The encrypted contact data may be imported into a contact data table of the third-party application. So, other third-party applications will be unable to access the encrypted contact data in the contact data table of the third-party application. Even if the third-party application implements an operation on the encrypted contact data in the contact data table, such as adding data, deleting data, or modifying data, it will be unable for other third-party applications to know the operation on the contact data by the third-party application. Thus the safety of the contact data can be improved. Furthermore, the encrypted contact data in the contact data table of the third-party application may be uploaded to a cloud server. In this way, even if they are lost, the contact data can be recovered from the cloud server without causing loss to the third-party application. Therefore, the reliability of the contact data can be improved.

### BRIEF DESCRIPTION OF THE DRAWINGS

In order to illustrate technical solutions of the present invention more clearly, a brief description of drawings that assists the description of embodiments of the invention will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a contact management method for a third-party application according to one embodiment of the present invention;

FIG. 2 is a flowchart of a contact management method for a third-party application according to another embodiment of the present invention;

FIG. 3 is a schematic diagram of a contact management apparatus for a third-party application according to yet another embodiment of the present invention;

FIG. 4 is a schematic diagram of a contact management apparatus for a third-party application according to yet another embodiment of the present invention.

### DETAILED DESCRIPTION OF ILLUSTRATED EMBODIMENTS

In order to make technical solutions of the present invention more apparent, the present invention will be described clearly and completely hereinafter with reference to accompanying drawings in embodiments of the present invention. It is apparent that the embodiments described hereafter are only part of the embodiments of the present invention, but not all of the embodiments. On the basis of the embodiments of the present invention, other embodiments obtained by an ordinary skilled in the art of the present invention without creative work are protected by the present invention.

One embodiment of the present invention provides a contact management method, a contact management apparatus and a contact management system for a third-party application, in which safety and reliability of the contact data can be improved. The present invention will be illustrated in detail hereinafter.

In general, a third-party application may refer to a program written to work within an operating system, but is written by individuals or companies other than the provider of the operating system. The third-party application may be a standalone program or can be a small plugin that add functionality to an existing parent program. For a specific kind of electrical hardware device, for example, a mobile phone or a personal assistant device (PAD), its manufacturer or its operating system provider will develop some supporting applications for the device. Apart from these applications, other individuals, organizations, and companies may also develop some applications or application plugins for the device. So, the applications or application plugins developed by other individuals, organizations, or companies are usually called “third party applications.”

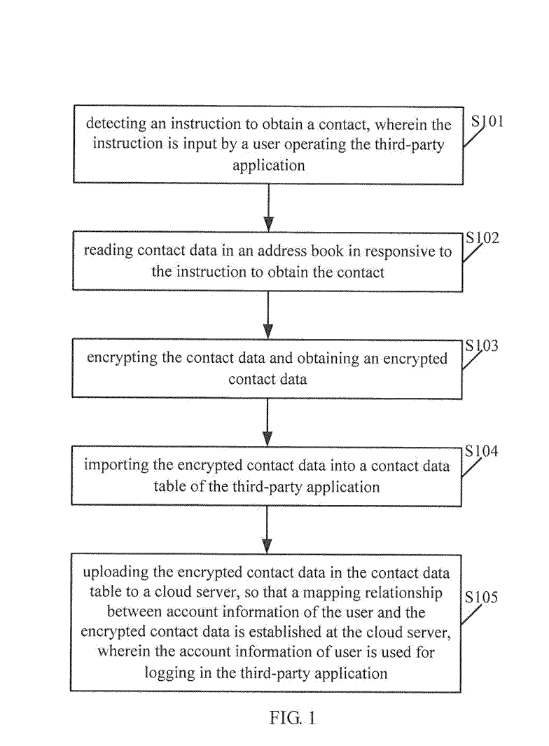

Referring to FIG. 1, it is a flowchart of a contact management method for a third-party application according to one embodiment of the present invention. Wherein the contact management method for a third-party application shown in FIG. 1 may be applied to terminal devices such as smart phones (e.g. Android phones, iOS phones, etc), tablet PCs, personal digital assistants, mobile internet devices (MID), personal computers (PC), etc, which will not be limited in embodiments of the present invention. As shown in FIG. 1, the contact management method tor a third-party application may comprise the following steps.

Step S101 is: detecting an instruction to obtain a contact, wherein the instruction is input by a user for operating the third-party application.

In the embodiment of the present invention, after a user logs in the third-party application by using account information at a terminal device, the user may implement an operation, such as a single or double click, on a plug-in for obtaining contacts which is set in the third-party application. Thereby, inputting an instruction to obtain a contact may be triggered to the terminal device, so that the terminal device can detect the instruction to obtain the contact input by the user for operating the third-part application.

In the embodiment of the present invention, the third-part application may be an application. The application may include connect applications, such as email, instant messaging, GPS navigation, remote access, etc. The application may include business applications, such as mobile banking, stock tracking and trading, document processing, schedule planning, etc. The application may include lifestyle applications, such as e-commerce, bill payment, health monitoring, digital reading and social applications, etc. The application may also include entertainment applications, such as news, game, multimedia player, photograph and video editor, etc. There are not limited in embodiment of the present invention.

Step S102 is: reading contact data in an address book In responsive to the instruction to obtain the contact.

In the embodiment of the present invention, the contact data in the address book may be read at the terminal device in responsive to the instruction to obtain the contact. For example, in responsive to the instruction to obtain the contact, all of the contact data may be read from the address book in the terminal device, or a portion of the contact data instructed by the instruction may be read. The contact data usually include a contact name and a phone number, and may also include a vCard of the contact, which is not limited in embodiment of the present invention.

Step S103 is: encrypting the contact data and obtaining an encrypted contact data.

In the embodiment of the present invention, the contact data may be encrypted at the terminal device according to an encryption algorithm, such as Tea encryption algorithm, corresponding to the third-party application to obtain the encrypted contact data. In this way, it can be ensured that the encrypted contact data corresponding to the third-party application cannot be known by other third-party applications. Thus, the safety of the contact data can be improved. Different encryption algorithms generally correspond to different third-party applications, and the encryption algorithms corresponding to the third-party applications are generally set by developers of the third-party applications, which will not be limited in embodiments of the present invention.

In the embodiment of the present invention, the contact data may be extended at the terminal device with customized data, and the extended contact data may be encrypted at the terminal device to obtain the encrypted contact data. The customized data may include personal a homepage URL, a personal space URL, a personal avatar, etc, which will not be limited in embodiments of the present invention. By extending the contact data with customized data at the terminal device, the content of contact information can be enriched. Therefore, the disadvantage that the contact data in an address book cannot be extended at will and the content of contact information cannot be enriched can be improved.

Step S104 is: importing the encrypted contact data into a contact data table of the third-party application.

In the embodiment of the present invention, the encrypted contact data may be imported at the terminal device into a contact data table of the third-party application. Wherein, the contact data table of the third-party application is independent of the address book of the terminal device.

In the embodiment of the present invention, the contact data table of the third-party application may be set in the plug-in property of the third-party application as a plug-in of the third-party application.

In the embodiment of the present invention, the encrypted contact data may be imported at the terminal device into a memory of the third-party application.

Step S105 is; uploading the encrypted contact data in the contact data table to a cloud server, so that a mapping relationship between account information of the user and the encrypted contact data is established at the cloud server, wherein the account information of the user is used for logging in the third-pasty application.

In the embodiment of the present invention, the encrypted contact data in the contact data table may be uploaded to the cloud server, so that a mapping relationship between account information of the user and the encrypted contact data is established at the cloud server. Thus, even if they are lost, the contact data can be recovered from the cloud server without causing loss to the third-party application. Therefore, the reliability of the contact data can be improved.

In the method shown in FIG. 1, after detecting an instruction to obtain a contact input by a user for operating the third-party application, contact data in an address book may be read in responsive to the instruction to obtain the contact and may be encrypted to obtain an encrypted contact data. The encrypted contact data may be imported into a contact data table of the third-party application. So, other third-party applications will be unable to access the encrypted contact data in the contact data table of the third-party application. Even if the third-party application implements an operation on the encrypted contact data in the contact data table, such as adding data, deleting data, or modifying data, it will be unable for other third-party applications to know the operation on the contact data by the third-party application. Thus the safety of the contact data can be improved. Furthermore, in the method shown in FIG. 1, the encrypted contact data in the contact data table of the third-party application may be uploaded to a cloud server, in this way, even if they are lost, the contact data can be recovered from the cloud server without causing loss to the third-party application. Therefore, the reliability of the contact data can be improved.

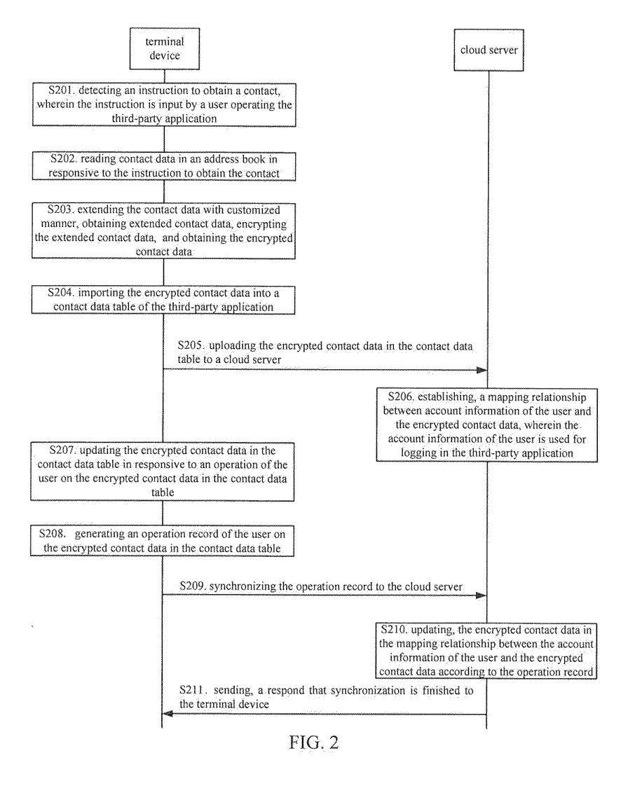

Referring to FIG. 2, it is a flowchart of a contact management method for a third-party application according to another embodiment of the present invention. Wherein the contact management method for a third-party application shown in FIG. 1 may be applied to terminal devices such as smart phones (e.g. Android phones, iOS phones, etc), tablet PCs, personal digital assistants, mobile internet devices (MID), personal computers (PC), etc., which will not be limited in embodiments of the present invention. As shown in FIG. 2, the contact management method for a third-party application may comprise the following steps.

Step S201 is: detecting, at a terminal device, an instruction to obtain a contact, wherein the instruction is input by a user for operating the third-party application.

In the embodiment of the present invention, after a user logs in the third-party application by using account information at a terminal device, the user may implement an operation, such as a single or double click, on a plug-in for obtaining contacts which is set in the third-party application. Thereby, inputting an instruction to obtain a contact may be triggered to the terminal device, so that the terminal device can detect the instruction to obtain the contact input by the user for operating the third-part application.

In the embodiment of the present invention, the third-part application may be an application. The application may include connect applications, such as email, instant messaging, GPS navigation, remote access, etc. The application may include business applications, such as mobile banking, stock tracking and trading, document processing, schedule planning, etc. The application may include lifestyle applications, such as e-commerce, bill payment, health monitoring, digital reading, social applications, etc. The application may also include entertainment applications, such as news, game, multimedia player, photograph and video editor, etc. These are not limited in embodiment of the present invention.

Step S202 is: reading, at the terminal device, contact data in an address book in responsive to the instruction to obtain the contact.

In the embodiment of the present invention, the contact data in the address book may be read at the terminal device in responsive to the instruction to obtain the contact. The contact data usually include a contact name and a phone number, and may also include a vCard of the contact, which is not limited in embodiment of the present invention.

Step S203 is: extending, at the terminal device, the contact data with customized data, obtaining extended contact data, encrypting the extended contact data, and obtaining the encrypted contact data.

In the embodiment of the present invention, the contact data may be extended at the terminal device with customized data, the extended contact data can be encrypted at the terminal device according to an encryption algorithm, such as Tea encryption algorithm, corresponding to the third-party application to obtain the encrypted contact data. Different encryption algorithms generally correspond to different third-party applications, and the encryption algorithms corresponding to the third-party applications are generally set by developers of the third-party applications, which will not be limited in embodiments of the present invention. The customized data may include a personal homepage URL, a personal space URL, a personal avatar, etc, which will not be limited in embodiments of the present invention. By extending the contact data with customized data at the terminal device, the content of contact information can be enriched. Therefore, the disadvantage that the contact data in an address book cannot be extended at will and the content of contact information cannot be enriched can be improved.

Step S204 is: importing, at the terminal device, the encrypted contact data into a contact data table of the third-party application.

In the embodiment of the present invention, the contact data table of the third-party application is independent of the address book of the terminal device.

Step S205 is: uploading, at the terminal device, the encrypted contact data in the contact data table to a cloud server.

In the embodiment of the present invention, the encrypted contact data in the contact data table may be uploaded by the terminal device to the cloud server, so that a mapping relationship between account information of the user and the encrypted contact data is established at the cloud server. Thus, even if they are lost, the contact data can be recovered from the cloud server without causing loss to the third-party application. Therefore, the reliability of the contact data can be improved.

Step S206 is: establishing, at the cloud server, a mapping relationship between account information of the user and the encrypted contact data, wherein the account information of the user is used for logging in the third-party application.

In the embodiment of the present invention, the user may register at the cloud server beforehand, when the encrypted contact data in the contact data table and account information of the user are uploaded by the terminal device to the cloud server, the mapping relationship between account information of the user and the encrypted contact data is established at the cloud server.

Step S207 is: updating, at the terminal device, the encrypted contact data in the contact data table in responsive to an operation of the user on the encrypted contact data in the contact data table.

Wherein, the operation of the user on the encrypted contact data in the contact data table includes adding, deleting, and modifying the encrypted contact data.

For example, one encrypted contact data may be directly added by the user in the contact data table of the third-party application, while the contact data in the address book at the terminal device does not need to be modified.

Step S208 is: generating, at the terminal device, an operation record of the user on the encrypted contact data in the contact data table.

For example, if one piece of encrypted contact data is directly added by the user in the contact data table of the third-party application, an operation record recording that the encrypted contact data is added by the user in the contact data table of the third-party application may be generated. In the operation record, the encrypted contact data added by the user is recorded.

For example, if one piece of encrypted contact data is directly deleted by the user in the contact data table of the third-party application, an operation record recording that the encrypted contact data is deleted by the user in the contact data table of the third-party application may be generated. In the operation record, the encrypted contact data deleted by the user is recorded.

Step S209 is: synchronizing, at the terminal device, the operation record to the cloud server.

Step S210 is: updating, at the cloud server, the encrypted contact data in the mapping relationship between the account information of the user and the encrypted contact data according to the operation record.

In the embodiment of the present invention, after updating, at the cloud server, the encrypted contact data in the mapping relationship between the account information of the user and the encrypted contact data according to the operation record, the encrypted contact data in the mapping relationship between the account, information of the user and the encrypted contact data established at the cloud server will be consistent with the encrypted contact data in the contact data table of the third-party application.

Step S211 is: sending, at the cloud server, a respond indicating that the synchronization is finished to the terminal device.

In the method shown in FIG. 2, after detecting an instruction to obtain a contact input by a user for operating the third-party application, contact data in an address book may be read in responsive to the instruction to obtain the contact and may be encrypted to obtain an encrypted contact data. The encrypted contact data may be imported into a contact data table of the third-party application. So, other third-party applications will be unable to access the encrypted contact data in the contact data table of the third-party application. Even if the third-party application implements an operation on the encrypted contact data in the contact data table, such as adding data, deleting data, or modifying data, it will be unable for other third-party applications to know the operation on the contact data by the third-party application. Thus, the safety of the contact data can be improved. Furthermore, in the method shown in FIG. 2, the encrypted contact data in the contact data table of the third-party application may be uploaded to a cloud server. In this way, even if they are lost, the contact data can be recovered from the cloud server without causing loss to the third-party application. Therefore, the reliability of the contact data can be improved. Moreover, in the method shown FIG. 2, in responsive to an operation of the user on the encrypted contact data in the contact data table, the encrypted contact data in the contact data table may be updated, and an operation of the user on the encrypted contact data in the contact data table, an operation record of the user on the encrypted contact data in the contact data table may be generated and synchronized to the cloud server, so that the encrypted contact data in the mapping relationship between the account information of the user and the encrypted contact data can be updated at the cloud server according to the operation record. Thus, the encrypted contact data in the contact data table of the third-party application and the encrypted contact data in the mapping relationship between the account information of the user and the encrypted contact data established at the cloud server can be real-timely consistent with each other.

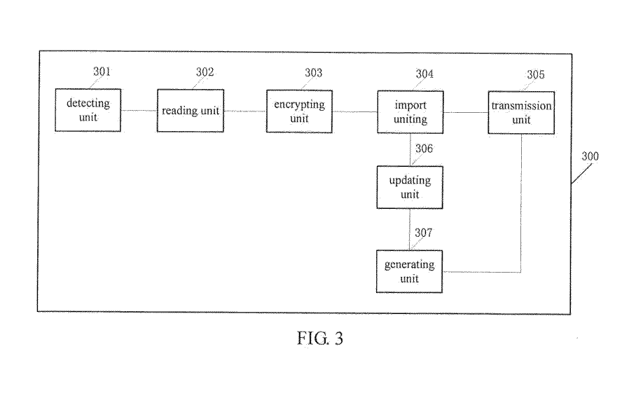

Referring to FIG. 3, it is a schematic diagram of a contact management apparatus for a third-party application according to yet another embodiment of the present invention. Wherein the contact management apparatus for a third-party application shown in FIG. 3 may be applied to terminal devices such as smart phones (e.g. Android phones, iOS phones, etc), tablet PCs, personal digital assistants, mobile internet devices (MID), personal computers (PC), etc., which will not be limited in embodiments of the present invention. As shown in FIG. 3, the contact management apparatus 300 for a third-party application may comprise: a detecting unit 301, a reading unit 302, an encrypting unit 303, an import uniting 304, and a transmission unit 305.

The detecting unit 301 is configured to detect an instruction to obtain a contact, wherein the instruction is input by a user for operating the third-party application.

The reading unit 302 is configured to read contact data in an address book in responsive to the instruction to obtain the contact.

The encrypting unit 303 is configured to encrypt the contact data and obtain an encrypted contact data.

The import uniting 304 is configured to import the encrypted contact data into a contact data table of the third-party application.

The transmission unit 305 Is configured to upload the encrypted contact data in the contact data table to a cloud server, so that a mapping relationship between account information of the user and the encrypted contact data is established at the cloud servers, wherein the account information of the user is used for logging in the third-party application.

In the embodiment of the present invention, the encrypting unit 303 is specifically configured to extend the contact data with customized data, obtain extended contact data, encrypt the extended contact data, and obtain an encrypted contact data.

In the embodiment, of the present invention, the contact management apparatus shown in FIG. 3 may also comprise: an updating unit 306 and a generating unit 307.

The updating unit 306 is configured to update the encrypted contact data in the contact data table in responsive to an operation of the user on the encrypted contact data in the contact data table.

The generating unit 307 is configured to generate an operation record of the user on the encrypted contact data in the contact data table.

The transmission unit 305 is further configured to synchronize the operation record to the cloud server, so that the encrypted contact data in the mapping relationship between the account information of the user and the encrypted contact data is updated at the cloud servers according to the operation record.

In the embodiment of the present invention, the contact data table of the third-party application may be stored in the import uniting 304, so that the encrypted contact data of the contact data table stored in the import uniting 304 may be updated by the updating unit 306 in responsive to an operation of the user on the encrypted contact data in the contact data table.

Given the above, safety and reliability of the contact data can be improved in the apparatus shown in FIG. 3.

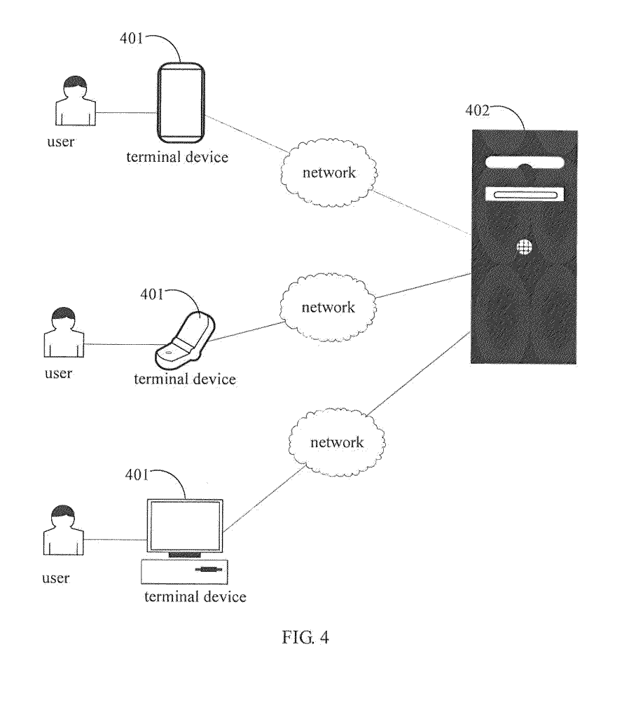

Referring to FIG. 4, it is a schematic diagram of a contact management apparatus for a third-party application according to yet another embodiment of the present invention. The contact management apparatus for a third-party application shown in FIG. 4 include a terminal device 401 and a cloud server 402. The terminal device 401 and the cloud server 402 are connected via a network, such internet.

The terminal device 401 is configured to: detect an instruction to obtain a contact wherein the instruction is input by a user for operating the third-party application; read contact data in an address book in responsive to the instruction to obtain the contact; encrypt the contact data and obtain an encrypted contact data; import the encrypted contact data into a contact data table of the third-party application; and upload the encrypted contact data in the contact data table to the cloud server 402.

The cloud server 402 is configured to establish a mapping relationship between account information of the user and the encrypted contact data, wherein the account information of the user is used for logging in the third-party application.

In the embodiment of the present invention, the terminal device 401 is specifically configured to extend the data of the contact with customized data, obtain extended contact data, encrypt the extended data of the contact, and obtain the encrypted contact data.

In the embodiment of the present invention, the terminal device 401 is further configured to update the encrypted contact data in the contact data table in responsive to an operation of the user on the encrypted contact data in the contact data table; generate an operation record of the user on the encrypted contact data in the contact data table; and synchronize the operation record to the cloud server 402.

Accordingly, the cloud server 402 is further configured to update the encrypted contact data in the mapping relationship between the account information of the user and the encrypted contact data according to the operation record.

Given the above, safety and reliability of the contact data can be improved in the system shown in FIG. 4.

A computer storage medium is further disclosed, which storing computer-executable instructions that, when executed by a processor, perform all of steps of the method shown in FIG. 1.

Those skilled in the art will understand that whole or parts of the process in the above-described embodiments can be implemented by controlling relevant hardware using programs on the terminal device, and can be implemented together by controlling relevant hardware using programs on the cloud server. The programs on the terminal device can be stored in computer-readable storage media of the terminal device, and the programs on the cloud server can be stored in computer-readable storage media of the cloud server. Further, the storage media can be a flash drive, read-only storage memory (ROM), or random access memory (RAM), magnetic disk, optical disk, etc.

A contact management method, a contact management apparatus and a contact management system for a third-party application disclosed by embodiments of the present invention are described in detail. The foregoing descriptions are merely exemplary embodiments of the present invention, and not intended to limit the protection scope of the present invention. Any variation or replacement made by persons of ordinary skills in the art without departing from the spirit of the present invention shall fall within the protection scope sought by the appended claims.

1. A contact management method for a third-party application, comprising:
detecting an instruction to obtain a contact, wherein the instruction is input by a user for operating the third-party application;
reading contact data in an address book in responsive to the instruction to obtain the contact;
encrypting the contact data and obtaining an encrypted contact data;
importing the encrypted contact data into a contact data table of the third-party application; and
uploading the encrypted contact data in the contact data table to a cloud server, so that a mapping relationship between account information of the user and the encrypted contact data is established at the cloud server, wherein the account information of the user Is used for logging in the third-party application.

2. The contact management method according to claim 1, wherein said encrypting comprising:
extending the contact data with customized data, and obtaining extended contact data; and
encrypting the extended contact data, and obtaining the encrypted contact data.

3. The contact management method according to claim 1, further comprising:
updating the encrypted contact data in the contact data table in responsive to an operation of the user on the encrypted contact data in the contact data table;
generating an operation record of the user on the encrypted contact data in the contact data table; and
synchronizing the operation record to the cloud server, so that the encrypted contact data in the mapping relationship between the account information of the user and the encrypted contact data is updated at the cloud server according to the operation record.

4. A contact management method for a third-party application, comprising:
detecting, at a terminal device, an instruction to obtain a contact, wherein the instruction is input by a user for operating the third-party application;
reading, at the terminal device, contact data in an address book in responsive to the instruction to obtain the contact;
encrypting, at the terminal device, the contact data and obtaining an encrypted contact data;
importing, at the terminal device, the encrypted contact data into a contact data table of the third-party application;
uploading, at the terminal device, the encrypted contact data in the contact data table to a cloud server; and
establishing, at the cloud server, a mapping relationship between account information of the user and the encrypted contact data, wherein the account information of the user is used for logging in the third-party application.

5. The contact management method according to claim 4, wherein said encrypting comprising:
extending, at the terminal device, the contact data with customized data, and obtaining extended contact data; and
encrypting, at the terminal device, the extended contact data, and obtaining the encrypted contact data.

6. The contact management method according to claim 4, further comprising:
updating, at the terminal device, the encrypted contact data in the contact data table in responsive to an operation of the user on the encrypted contact data in the contact data table;
generating, at the terminal device, an operation record of the user on the encrypted contact data in the contact data table;
synchronizing, at the terminal device, the operation record to the cloud servers; and
updating, at the cloud server, the encrypted contact data in the mapping relationship between the account information of the user and the encrypted contact data according to the operation record.

7. (canceled)

8. A contact management apparatus for a third-party application, comprising:
a detecting unit configured to detect an instruction to obtain a contact, wherein the instruction is input by a user for operating the third-party application;
a reading unit configured to read contact data In an address book in responsive to the instruction to obtain the contact;
an encrypting unit configured to encrypt the contact data and obtain an encrypted contact data;
an import uniting configured to import the encrypted contact data into a contact data table of the third-party application; and
a transmission unit configured to upload the encrypted contact data in the contact data table to a cloud server, so that a mapping relationship between account information of the user and the encrypted contact data is established at the cloud server, wherein the account information of the user is used for logging in the third-party application.

9. The contact management apparatus according to claim 8, wherein the encrypting unit is specifically configured to extend the contact data with customized data, obtain extended contact data, encrypt the extended contact data, and obtain an encrypted contact data.

10. The apparatus according to claim 8, further comprising;
an updating unit configured to update the encrypted contact data in the contact data table in responsive to an operation of the user on the encrypted contact data in the contact data table; and
a generating unit configured to generate an operation record of the user on the encrypted contact data in the contact data table, wherein:
the transmission unit is further configured to synchronize the operation record to the cloud server, so that the encrypted contact data in the mapping relationship between the account information of the user and the encrypted contact data is updated at the cloud servers according to the operation record.

11. A contact management system for a third-party application, comprising a terminal device and a cloud server, wherein:
the terminal device is configured to: detect an instruction to obtain a contact, wherein the instruction is input by a user for operating the third-party application; read contact data in an address book in responsive to the instruction to obtain the contact; encrypt the contact data and obtain an encrypted contact data; import the encrypted contact data into a contact data table of the third-party application; and upload the encrypted contact data in the contact data table to the cloud server; and
the cloud server is configured to establish a mapping relationship between account information of the user and the encrypted contact data, wherein the account information of the user is used for logging in the third-party application.

12. The contact management system according to claim 11, wherein the terminal device is specifically configured to extend the data of the contact with customized data, obtain extended contact data, encrypt the extended data of the contact, and obtain the encrypted contact data.

13. The system according to claim 11, wherein:
the terminal device is further configured to update the encrypted contact data in the contact data table in responsive to an operation of the user on the encrypted contact data in the contact data table; generate an operation record of the user on the encrypted contact data in the contact data table; and synchronize the operation record to the cloud server;
the cloud server is further configured to update the encrypted contact data in the mapping relationship between the account information of the user and the encrypted contact data according to the operation record.

14. The contact management method according to claim 2, further comprising:
updating the encrypted contact data in the contact data table in responsive to an operation of the user on the encrypted contact data in the contact data table;
generating an operation record of the user on the encrypted contact data in the contact data table; and
synchronizing the operation record to the cloud server, so that the encrypted contact data in the mapping relationship between the account information of the user and the encrypted contact data is updated at the cloud server according to the operation record.

15. The contact management method according to claim 5, further comprising:
updating, at the terminal device, the encrypted contact data in the contact data table in responsive to an operation of the user on the encrypted contact data in the contact data table;
generating, at the terminal device, an operation record of the user on the encrypted contact data in the contact data table;
synchronizing, at the terminal device, the operation record to the cloud servers; and
updating, at the cloud server, the encrypted contact data in the mapping relationship between the account, information of the user and the encrypted contact data according to the operation record.

16. The apparatus according to claim 9, further comprising:
an updating unit configured to update the encrypted contact data in the contact data table in responsive to an operation of the user on the encrypted contact data in the contact data table; and
a generating unit configured to generate an operation record of the user on the encrypted contact data in the contact data table, wherein:
the transmission unit is further configured to synchronize the operation record to the cloud server, so that the encrypted contact data in the mapping relationship between the account information of the user and the encrypted contact data is updated at the cloud servers according to the operation record.

17. The system according to claim 12, wherein:
the terminal device is further configured to update the encrypted contact data in the contact data table in responsive to an operation of the user on the encrypted contact data in the contact data table; generate an operation record of the user on the encrypted contact data in the contact data table; and synchronize the operation record to the cloud server;
the cloud server is further configured to update the encrypted contact data in the mapping relationship between the account information of the user and the encrypted contact data according to the operation record.
